(19) United States
(12) Patent Application Publication
(10) Pub. No.: US 2005/0069311 A1
(43) Pub. Date: Mar. 31, 2005

(54) Photographic device

(76) Inventor: Yong Zhu, Wyfold Industry City (CN)

Correspondence Address: Raymond Y. Chan, Suite 128, 108 N. Ynez Ave., Monterey Park, CA, 91754, US

(21) Appl. No.: 10/949,084

(22) Filed: Sep. 24, 2004

(30) Foreign Application Priority Data
Sep. 26, 2003 (CN) 03274889.2

(51) Int. Cl. G03B 1/00

(52) U.S. Cl. 396/413

(57) ABSTRACT

A photographic device includes a camera housing and a film driving arrangement. The camera housing has a film storage chamber for rotatably supporting a film housing of a film roll, and an exposure cavity communicating with the film storage chamber. The film driving arrangement is supported in the camera housing and adapted to be actuated between an manual photographing operation and a film rewinding operation, wherein during the manual photographing operation, the film driving arrangement is adapted for manually pulling the reserved portion of the film layer out of the film housing to form the capture portion at the exposure cavity for capturing image, and wherein during the film rewinding operation, the film driving arrangement is adapted for being electrically actuated to drive the film axis to rotate in a rewinding direction for pulling the capture portion of the film layer back in the film housing.

### BACKGROUND OF THE PRESENT INVENTION

1. Field of Invention

The present invention relates to a photographic device, and more particularly to a camera comprising a film driving arrangement which is adapted to minimize film rewind time, while allowing the overall structure of the camera to be as simple as possible.

2. Description of Related Arts

The Camera as a visual recording equipment is one of the most important instruments for image recordings. Over the years, photographs taken by cameras not only serve such entertainment purpose as capturing funny and memorable events, but also facilitate improvement and widespread of knowledge so as to provide an important channel for scientific and social improvement.

A conventional camera usually comprises a camera housing having a film storage chamber and an exposure cavity communicated with the film storage chamber, an image capturing lens provided at a front capturing side of the camera housing and communicated with the exposure cavity, and an actuation unit operatively provided on the camera housing to operate the image capturing lens for allowing light to pass therethrough to reach the exposure cavity for a predetermined period of time.

Conventionally, a film roll is utilized to permanently record the image captured by the image capturing lens. A typical film roll usually comprises a cylindrical film housing having a film opening, and a flexible film layer having a reserved portion rollingly and overlappedly received in the film housing, and a capture portion movably extended to the exposure cavity via the film opening for capturing an image through light exposure controlled by the actuation unit.

Very often, the conventional camera further comprises a film driving arrangement engaging with the film roll for driving the capture portion to move with respect to the film housing in such a manner that when the image capturing lens has been actuated to allow light passing therethrough to reach the exposure cavity for a predetermined period of time, the capture portion is driven to move opposite to the film housing so as to pull a predetermined length of the reserved portion out of the film housing to reach the exposure cavity for next light exposure. As a result, during the course of a normal operation of the film roll, the length of the capture portion and the reserved portion is inversely proportional. When all the reserved portion has been used up for light exposure, the film driving arrangement is adapted to rewind the entire film layer going back and received in the film housing.

As a matter of conventional art, there exist two types of film driving arrangements, one being characterized as manually operated, and the other electrically driven. Both possess inherent discrepancies. For example, for electrically driven film driving arrangement, the overall electrical and mechanical components tend to be complexly interlinked with each other so that manufacturing of which would involve considerable cost and this inevitably raises the ultimate selling price of the camera. Conversely, for the manually operated one, it is very inconvenient and time-consuming in that the user has to manually rewind the entire film layer every time he/she has used up a film roll. This is especially annoying where he/she is traveling with a travel tour in which he/she is simply not affordable to spend such a long time in rewinding the film layer due to the time constraint imposed by the travel guide at a particular travel spot.

### SUMMARY OF THE PRESENT INVENTION

A main object of the present invention is to provide a photographic device comprising a film driving arrangement which is adapted to minimize film rewind time, while allowing the overall structure of the photographic device to be as simple as possible.

Another object of the present invention is to provide a photographic device which adopts manually operated film driving arrangement and electrically driven film driving arrangement in conventional cameras for effectively resolving the inherent discrepancies thereof.

Accordingly, the present invention provides a photographic device for capturing an image stored in a film roll comprising a film housing having a film opening and a film axis rotatably provided on the film housing, and a flexible film layer having one end attached to the film axis to define a reserved portion overlappedly encircling the film axis in the film housing, and a capture portion extending out of the film housing through the film opening, wherein the photographic device comprises:
a camera housing having a film storage chamber for supporting the film housing of the film roll, and an exposure cavity communicating with the film storage chamber, wherein the capture portion of the film layer is adapted for extending to the exposure cavity; and
a film driving arrangement supporting in the camera housing and adapted to be actuated between an manual photographing operation and a film rewinding operation, wherein during the manual photographing operation, the film driving arrangement is adapted for manually pulling the reserved portion of the film layer out of the film housing to form the capture portion at the exposure cavity for capturing image, and wherein during the film rewinding operation, the film driving arrangement is adapted for being electrically actuated to drive the film axis to rotate in a rewinding direction for pulling the capture portion of the film layer back in the film housing.

These and other objectives, features, and advantages of the present invention will become apparent from the following detailed description, the accompanying drawings, and the appended claims.

### BRIEF DESCRIPTION OF THE DRAWINGS

FIG. 1 is a section side view of a photographic device according to a preferred embodiment of the present invention.

### DETAILED DESCRIPTION OF THE PREFERRED EMBODIMENT

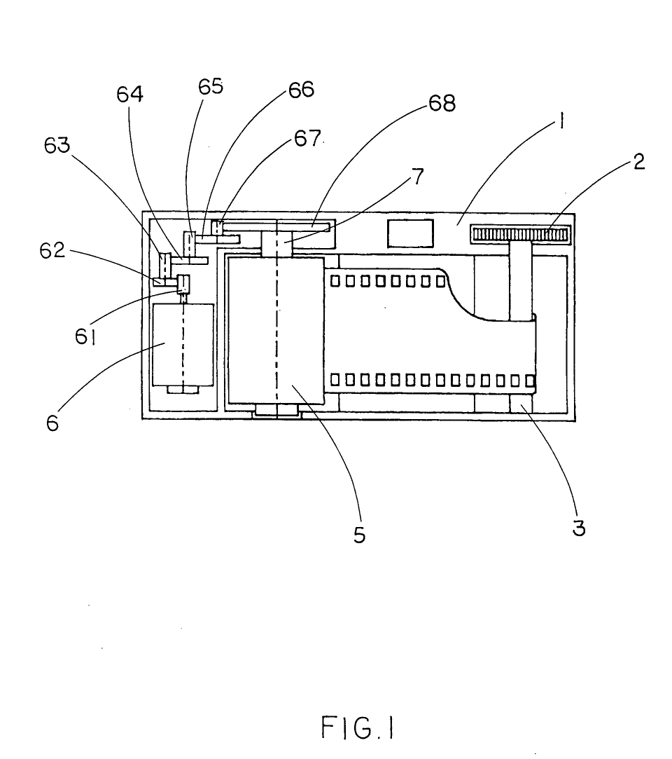

Referring to FIG. 1 of the drawings, a photographic device for a photographic device according to a preferred embodiment of the present invention is illustrated, in which the photographic device comprises a camera housing 1 and a film driving arrangement.

The film roll, being a conventional film roll, comprises a film housing 5 having a film opening and a film axis rotatably provided on the film housing 5, and a flexible film layer having a first end attached to the film axis to define a reserved portion overlappedly encircling the film axis in the film housing 5, and a capture portion extending out of the film housing 5 through the film opening.

The camera housing 1 has a film storage chamber for supporting the film housing 5 of the film roll, and an exposure cavity communicating with the film storage chamber, in which the capture portion of the film layer is adapted for extending to the exposure cavity.

The photographic device is adapted to connect with a camera lens so as to form a camera. In such a case, the camera lens would be mounted at a front side of the camera housing 1 for allowing light passing therethrough to reach the exposure cavity for impinging on the capture portion of the film layer.

The film driving arrangement is supported in the camera housing 1 and adapted to be actuated between a manual photographing operation, and a film rewinding operation, wherein during the manual photographing operation, the film driving arrangement is adapted for manually pulling the reserved portion of the film layer out of the film housing 5 to form the capture portion at the exposure cavity for capturing image, and wherein during the film rewinding operation, the film driving arrangement is adapted for being electrically actuated to drive the film axis to rotate in a rewinding direction for pulling the capture portion of the film layer back in the film housing 5.

Specifically, the film driving arrangement comprises a manual rotor device and a film rewinding device. The manual rotor device is mounted on the camera housing 1 and adapted for engaging with the capture portion of the film layer so as to rotatably pull the reserved portion of the film layer moving out of the film housing 5 to form the capture portion at the exposure cavity for capturing image.

Conversely, the film rewinding device, being electrically-powered, is disposed in the camera housing 1 to communicate with the film axis, such that the film rewind device is adapted for being actuated to drive the film axis to rotate in a direction for rolling the capture portion of the film layer back in the film housing 5.

According to the preferred embodiment of the present invention, the manual rotor device comprises a rolling axis 3 rotatably mounted in the camera housing 1 at a position spacedly apart from the film storage chamber, and a manual actuator 2 operatively connected with a top extending end of the rolling axis 3 and extended at an exterior of the camera housing 1 for allowing a user to drive the rolling axis 3 to rotate by manually rotating the manual actuator 2. Referring to FIG. 1 of the drawings, a second end of the film layer at the capture portion is arranged to engage with the rolling axis 3 while extending out of the film housing 5 in such a manner that the capture portion is adapted to be rolled in an overlapped manner encircling the rolling axis 3 so that the reserved portion of the film layer is pulled out from the film housing 5 for image capturing.

It is worth mentioning that since the manual film rotor is actuated manually, the reserved portion is arranged to be pulled out from the film housing 5 for a predetermined length adequate for capturing an image at the exposure cavity. At the same time, the capture portion of the film layer which has already been utilized for image capturing is rolled at the rolling axis 3 so as to temporarily rest thereon. Thus, the film layer is preferably pre-divided into a twenty four or thirty six partitions adapted for capturing a corresponding number of images. In other words, the predetermined length mentioned above is a distance between each of the partitions so that by rolling that predetermined length of the capture portion, the photographic device is ready for taking another photo.

The film rewinding device comprises a motor 6 supported within the camera housing 1, and a film rewinding pin 7 rotatably supported on top of the film storage chamber in such a manner that when the film rewinding device is at the manual photographing operation, the film rewinding pin 7 is moved apart from the film axis so as to disengage therewith, whereas when the film rewinding device is in the film rewinding operation, the film rewinding pin 7 is driven to engage with the film axis of the film roll for rotatably driving the film axis rotating within the film housing 5 in the rewinding direction.

Accordingly, the film rewinding device further comprises a gear assembly operatively connecting between the motor 6 and the film rewinding pin 7 for transmitting the rotational driving force from the motor 6 to the film rewinding pin 7 in a controlled manner. When the film rewinding pin 7 is engaging with film axis, the film rewinding pin 7 is adapted to rotatably drive the film axis rotating in the rewinding direction which is opposite to that of the rolling axis 3 and rewinds the film back to the film housing 5.

As shown in FIG. 1 of the drawings, the gear assembly comprises first through eight transmission gears 61, 62, 63, 64, 65, 66, 67, 68 engaging between the motor 6 and the film rewinding pin 7 in the camera housing 1 in such a manner that when the film rewinding device is in the film rewinding operation, the film rewinding pin 7 is driven to engage with the film axis and that a rotational torque generated by the motor 6 is decelerated and transmitted through the gear assembly to drive the film rewinding pin 7 which then drives the film axis of the film roll rotating in the rewinding direction. As a result, by actuating the film rewinding device, the film layer is automatically rewound so as to available for replacement or detaching from the camera housing 1.

Moreover, the motor is preferably electrically powered by direct current, and is transversely disposed in a side edge portion of the camera housing 1 for driving the film rewinding pin 7 to rotate subject to mechanical transmission through the gear assembly. The gear assembly is engagingly provided between the film storage compartment and the motor so that an overall spatial occupation of the film rewinding device can be minimized within the camera housing 1.

From the forgoing descriptions, it can be shown that the above-mentioned objects have been substantially accomplished. By adopting manual rolling of the film layer during photographing and automatic film rewinding at the time when the entire film layer has been used up, the structure of the camera can be kept as simple as possible, and that the time required for manual operation would also be minimized.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A photographic device for capturing an image stored in a film roll comprising a film housing having a film opening and a film axis rotatably provided on said film housing, and a flexible film layer having one end attached to said film axis to define a reserved portion overlappedly encircling said film axis in said film housing, and a capture portion extending out of said film housing through said film opening, wherein said photographic device comprises:
a camera housing having a film storage chamber for supporting said film housing of said film roll, and an exposure cavity communicating with said film storage chamber, for said capture portion of said film layer extending thereto; and
a film driving arrangement supporting in said camera housing and adapted to be actuated between an manual photographing operation and a film rewinding operation, wherein during said manual photographing operation, said film driving arrangement is adapted for manually pulling said reserved portion of said film layer out of said film housing to form said capture portion at said exposure cavity for capturing image, and wherein during said film rewinding operation, said film driving arrangement is adapted for being electrically actuated to drive said film axis to rotate in a rewinding direction for rolling said capture portion of said film layer back in said film housing.

2. The photographic device, as recited in claim 1, wherein said film driving arrangement comprises a manual rotor device mounted on said camera housing and adapted for engaging with said capture portion of said film layer so as to rotatably pull said reversed portion of said film layer moving out of said film housing to form said capture portion at said exposure cavity for capturing image when said film driving arrangement is in said manual photographing operation, and a film rewinding device disposed in said camera housing for communicating with said film axis, such that said film rewinding device is adapted for driving said film axis to rotate in a direction for rolling said capture portion of said film layer back in said film housing.

3. The photographic device, as recited in claim 2, wherein said manual rotor device comprises a rolling axis rotatably mounted in said camera housing at a position spacedly apart from said film storage chamber, and a manual actuator connected with an extending end of said rolling axis and extended at an exterior of said camera housing for allowing a user to drive said rolling axis to rotate by manually rotating said manual actuator, wherein said capture portion is adapted to be rolled on said rolling axis in an overlapped manner encircling said rolling axis for pulling out said reserved portion of said film layer.

4. The photographic device, as recited in claim 2, wherein said film rewinding device comprises a motor supported within said camera housing, a film rewinding pin rotatably supported on said camera housing for aligning with said film axis of said film roll, and a gear assembly communicating said motor with said film rewinding pin for transmitting a rotational movement generated by said motor to said film rewinding pin for rotatably driving said film axis to rotate when said film rewinding device is in said film rewinding operation.

5. The photographic device, as recited in claim 3, wherein said film rewinding device comprises a motor supported within said camera housing, a film rewinding pin rotatably supported on said camera housing for aligning with said film axis of said film roll, and a gear assembly communicating said motor and said film rewinding pin for transmitting a rotational movement generated by said motor to said film rewinding pin for rotatably driving said film axis to rotate when said film rewinding device is in said film rewinding operation.

6. The photographic device, as recited in claim 4, wherein said gear assembly comprises first through eighth transmission gears engaging between said motor and said film rewinding pin for transmitting and decelerating a rotational movement generated by said motor to said film rewinding pin when said film rewinding device is at said film rewinding operation, such that said motor is adapted for controllably driving said film rewinding pin to roll said film layer back to said film housing.

7. The photographic device, as recited in claim 5, wherein said gear assembly comprises first through eighth transmission gears engaging between said motor and said film rewinding pin for transmitting and decelerating a rotational movement generated by said motor to said film rewinding pin when said film rewinding device is at said film rewinding operation, such that said motor is adapted for controllably driving said film rewinding pin to roll said film layer back to said film housing.

8. The photographic device, as recited in claim 5, wherein said motor, which is electrically powered by direct current, is transversely disposed in a side edge portion of said camera housing for driving said film rewinding pin to rotate through said gear assembly, wherein said gear assembly is engagingly provided between said film storage compartment and said motor so as to minimize an overall spatial occupation of said film rewinding device.

9. The photographic device, as recited in claim 6, wherein said motor, which is electrically powered by direct current, is transversely disposed in a side edge portion of said camera housing for driving said film rewinding pin to rotate through said gear assembly, wherein said gear assembly is engagingly provided between said film storage compartment and said motor so as to minimize an overall spatial occupation of said film rewinding device.

10. The photographic device, as recited in claim 7, wherein said motor, which is electrically powered by direct current, is transversely disposed in a side edge portion of said camera housing for driving said film rewinding pin to rotate through said gear assembly, wherein said gear assembly is engagingly provided between said film storage compartment and said motor so as to minimize an overall spatial occupation of said film rewinding device.

11. A film driving arrangement for a photographic device which comprises a camera housing having a film storage chamber for supporting a film roll comprising a film housing and a flexible film layer having a capture portion and a reserved portion normally received in said film housing, and an exposure cavity communicating with said film storage chamber for light exposure at said capture portion of said flexible film layer extended from said film housing, wherein said film driving arrangement comprises:
a manual rotor device and a film rewinding device provided in said camera housing, and adapted to be actuated between a manual photographing operation and a film rewinding operation, wherein during said manual photographing operation, said manual rotor device is adapted for manually pulling said reserved portion of said film layer out of said film housing to form said capture portion at said exposure cavity for capturing image, and wherein during said film rewinding operation, said film rewinding device is adapted for being electrically actuated to drive said film axis to rotate in a rewinding direction for rolling said capture portion of said film layer back in said film housing.

12. The film driving arrangement, as recited in claim 11, wherein said film driving arrangement comprises a manual rotor device mounted on said camera housing and adapted for engaging with said capture portion of said film layer so as to rotatably pull said reversed portion of said film layer moving out of said film housing to form said capture portion at said exposure cavity for capturing image when said film driving arrangement is in said manual photographing operation, and a film rewinding device disposed in said camera housing for communicating with said film axis, such that said film rewinding device is adapted to drive said film axis to rotate in a direction for rolling said capture portion of said film layer back in said film housing.

13. The film driving arrangement, as recited in claim 12, wherein said manual rotor device comprises a rolling axis rotatably mounted in said camera housing at a position spacedly apart from said film storage chamber, and a manual actuator connected with an extending end of said rolling axis and extended at an exterior of said camera housing for allowing a user to drive said rolling axis to rotate by manually rotating said manual actuator, wherein said capture portion is adapted to be rolled on said rolling axis in an overlapped manner encircling said rolling axis for pulling out said reserved portion of said film layer.

14. The film driving arrangement, as recited in claim 12, wherein said film rewinding device comprises a motor supported within said camera housing, a film rewinding pin rotatably supported on said camera housing for aligning with said film axis of said film roll, and a gear assembly communicating said motor and said film rewinding pin for transmitting a rotational movement generated by said motor to said film rewinding pin for rotatably driving said film axis to rotate when said film rewinding device is in said film rewinding operation.

15. The film driving arrangement, as recited in claim 13, wherein said film rewinding device comprises a motor supported within said camera housing, a film rewinding pin rotatably supported on said camera housing for aligning with said film axis of said film roll, and a gear assembly communicating said motor and said film rewinding pin for transmitting a rotational movement generated by said motor to said film rewinding pin for rotatably driving said film axis to rotate when said film rewinding device is in said film rewinding operation.

16. The film driving arrangement, as recited in claim 14, wherein said gear assembly comprises first through eighth transmission gears engaging between said motor and said film rewinding pin for transmitting and decelerating a rotational movement generated by said motor to said film rewinding pin when said film rewinding device is at said film rewinding operation, such that said motor is adapted for controllably driving said film rewinding pin to roll said film layer back to said film housing.

17. The film driving arrangement, as recited in claim 15, wherein said gear assembly comprises first through eighth transmission gears engaging between said motor and said film rewinding pin for transmitting and decelerating a rotational movement generated by said motor to said film rewinding pin when said film rewinding device is at said film rewinding operation, such that said motor is adapted for controllably driving said film rewinding pin to roll said film layer back to said film housing.

18. The film driving arrangement, as recited in claim 15, wherein said motor, which is electrically powered by direct current, is transversely disposed in a side edge portion of said camera housing for driving said film rewinding pin to rotate through said gear assembly, wherein said gear assembly is engagingly provided between said film storage compartment and said motor so as to minimize an overall spatial occupation of said film rewinding device.

19. The film driving arrangement, as recited in claim 16, wherein said motor, which is electrically powered by direct current, is transversely disposed in a side edge portion of said camera housing for driving said film rewinding pin to rotate through said gear assembly, wherein said gear assembly is engagingly provided between said film storage compartment and said motor so as to minimize an overall spatial occupation of said film rewinding device.

20. The film driving arrangement, as recited in claim 17, wherein said motor, which is electrically powered by direct current, is transversely disposed in a side edge portion of said camera housing for driving said film rewinding pin to rotate through said gear assembly, wherein said gear assembly is engagingly provided between said film storage compartment and said motor so as to minimize an overall spatial occupation of said film rewinding device.
